(19) United States
(12) Patent Application Publication
(10) Pub. No.: US 2025/0005753 A1
(43) Pub. Date: Jan. 2, 2025

(54) METHOD FOR POST-SURGERY ASSESSMENT OF RESIDUAL TUMOR BORDER ZONE BASED ON MEDICAL IMAGE OUT-PAINTING

(71) Applicant: KONINKLIJKE PHILIPS N.V., EINDHOVEN (NL)

(72) Inventors: GEORGE KOLOKOLNIKOV, HAMBURG (DE); RENAT KOZODAYEV, EINDHOVEN (NL)

(21) Appl. No.: 18/756,626

(22) Filed: Jun. 27, 2024

(30) Foreign Application Priority Data
Dec. 9, 2022 (WO) PCT/CN2022/137930

(51) Int. Cl. G06T 7/00

(52) U.S. Cl. CPC G06T 7/0012; G06T 2207/10132; G06T 2207/20084; G06T 2207/30024

(57) ABSTRACT

In one embodiment, a method, comprising: obtaining a correlation between the pre-operative ultrasound images and the post-operative histopathological images based on application of a fused image to a neural network; receiving post-operative ultrasound images; using the correlation to translate the post-operative ultrasound images to synthesized histopathology images; fusing the post-operative ultrasound images with the synthesized histopathology images; out-painting the synthesized histopathology images to a border zone remaining after the surgical procedure, the out-painting performed on a neural network; and displaying the out-painted, synthesized image with the post-operative ultrasound images.

### CROSS-REFERENCE TO RELATED APPLICATION

This application is a continuation-in-part application of PCT application No. PCT/CN2022/137930, filed Dec. 9, 2022, which is hereby incorporated by reference in its entirety.

### FIELD OF THE INVENTION

The present invention is generally related to imaging, and more particularly, to analysis of diagnostic images.

### BACKGROUND OF THE INVENTION

Cancer is the second leading cause of all deaths in the world. Timely diagnostics and treatment are crucial to prevent the fatal outcome, whether from first-time tumors or recurrent tumors. Prevention of recurrent cancers is important, as these cancers are often difficult to detect. However, preventative measures may have very detrimental effects on the quality of life of a patient. For instance, recurrent cancers may be more aggressive than the original cancer if the cancer has already spread to other parts of the body and/or the cancer has become resistant to treatment/therapy (e.g., chemotherapy/radiation therapy).

One of the treatment approaches is a surgical operation dedicated to removing a tumor. It is important to ensure that no malignant cells are left in a patient's body in the region of the surgical operation. The residual malignant cells in a patient may lead to a recurrent oncology disease.

Explaining further, tumor recurrence is an important problem in clinical practice. Local recurrence (e.g., where the cancer is in the same place as the original cancer or very close to it) is an important problem in cancer screenings, and poses challenges in a tumor operation. For instance, there is often a trade-off involved in surgical removal of malignant tumors and surrounding tissue. That is, physicians should weigh how much surrounding tissue can be removed without detrimentally affecting the quality of life of a patient, while removing a sufficient amount to prevent or mitigate the risk of a secondary recurrence. Physicians typically remove parts of the healthy tissue surrounding the cancerous tissue to maximize the chances that cancer will not spread. However, removing healthy tissue may affect the health of the patient, so physicians try to remove the tissue sparingly, which may lead to secondary cancer since the cancer cells may have already spread through lymph nodes. Consequently, there is a need to monitor tumor border zones to minimize regional recurrence and also, as a method for screening of operations.

### SUMMARY OF THE INVENTION

In one embodiment, a method, comprising: obtaining a correlation between the pre-operative ultrasound images and the post-operative histopathological images based on application of a fused image to a neural network; receiving post-operative ultrasound images; using the correlation to translate the post-operative ultrasound images to synthesized histopathology images; fusing the post-operative ultrasound images with the synthesized histopathology images; out-painting the synthesized histopathology images to a border zone remaining after the surgical procedure, the out-painting performed on a neural network; and displaying the out-painted, synthesized image with the post-operative ultrasound images.

These and other aspects of the invention will be apparent from and elucidated with reference to the embodiment(s) described hereinafter.

### BRIEF DESCRIPTION OF THE DRAWINGS

Many aspects of the invention can be better understood with reference to the following drawings, which are diagrammatic. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram that illustrates an example pre-operation medical ultrasound examination of a patient with a tumor, in accordance with an embodiment of the invention.

FIG. 2 is a schematic diagram that illustrates an example distribution of malignant cells along a selected profile line in a tumor.

FIG. 3 is a schematic diagram that illustrates an image generation algorithm.

FIG. 4 is a schematic diagram that illustrates image generation from a clinical perspective.

FIG. 5 is a schematic diagram that illustrates an image segmentation algorithm.

FIG. 6 is a schematic diagram that illustrates a method that uses a segmentation mask for image generation from the first and second diagnostic image modalities.

FIG. 7 is a schematic diagram that illustrates an MC-GAN algorithm example.

FIG. 8 is a schematic diagram that illustrates an example of training the MC-GAN algorithm.

FIG. 9 is a schematic diagram that illustrates an example in-operation fusion of ultrasound and histopathology imaging, in accordance with an embodiment of the invention.

FIG. 10 is a schematic diagram that illustrates an example image out-painting process based on a deep neural network for predicting cancerous cells of a tumor border zone remaining in a patient, in accordance with an embodiment of the invention.

FIG. 11 is a schematic diagram that illustrates an example post-operation medical ultrasound examination of a patient for determining whether a further surgical treatment of surrounding tissue is warranted, in accordance with an embodiment of the invention.

FIG. 12 is a flow diagram that illustrates an example recurrence assessment method, in accordance with an embodiment of the invention.

### DETAILED DESCRIPTION OF EMBODIMENTS

Disclosed herein are certain embodiments of a recurrence assessment system and method. In one embodiment, the recurrence assessment system and method provides for post-surgery assessment of residual malignant cells in a tumor border zone (e.g., organs at risk/neighboring organs near the metastasized organ). The recurrence assessment system and method may be based on a deep neural network that features extraction of data from an intra-operative histopathologic and/or non-invasive imaging modalities, including CT/MR/US. For instance, the recurrence assessment system and method may use an ultrasound image with a combined histology/histopathology image for analyzing combined information from both modalities so that the probability of tumors and/or risk of tumor reoccurrence utilizing the combined image (e.g., fused image) can be analyzed. In some embodiments, the recurrence assessment system and method enables a quality assessment of surgical operations performed on malignant tumors, for instance, to confirm that (all) malignant cells were removed from organs at risk, and to prevent the disease recurrence. In some embodiments, the recurrence assessment system and method features prognostic functionality that enables analysis of diagnostic images in a longitudinal study of patients, which may be applied in a clinical workflow setting to improve clinical benefits for patients during and/or after the surgery.

Having summarized certain features of a recurrence assessment system and method of the present disclosure, reference will now be made in detail to the description of a recurrence assessment system and method as illustrated in the drawings. While a recurrence assessment system and method will be described in connection with these drawings, there is no intent to limit it to the embodiment or embodiments disclosed herein. Further, although the description identifies or describes specifics of one or more embodiments, such specifics are not necessarily part of every embodiment, nor are all of any various stated advantages necessarily associated with a single embodiment. On the contrary, the intent is to cover alternatives, modifications and equivalents included within the principles and scope of the disclosure as defined by the appended claims. For instance, two or more embodiments may be interchanged or combined in any combination. Further, it should be appreciated in the context of the present disclosure that the claims are not necessarily limited to the particular embodiments set out in the description.

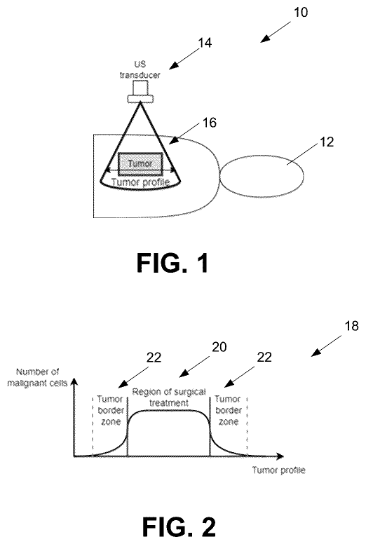

As an illustrative example of a clinical workflow in which certain embodiments of a recurrence assessment system and method may be implemented, attention is directed to FIG. 1, which illustrates an example pre-operation medical ultrasound examination of a patient with a tumor. For instance, FIG. 1 depicts a pre-operation step 10, where a patient 12 is examined with an imaging device 14. In this example, the imaging device comprises an ultrasound imaging device. An ultrasound swipe of a tumor region 16 is acquired, and saved for further image registration steps and for further reference. Based on this image, a tumor removal plan is developed.

Based on the tumor removal plan, during a surgical intervention, a tumor, tumorous organ, or parts of an organ(s) with a tumor or tumors are removed. In what is sometimes referred to as a regional recurrence, in some instances, the remaining surrounding tissue may contain malignant cells, or there may be secondary cancer that has spread to surrounding organs, as shown in FIG. 2. FIG. 2 shows a graph 18 showing an example distribution 18 of malignant cells along a selected profile line in a tumor. For instance, the y-axis of the graph 18 represents a number of malignant cells, and the x-axis represents the tumor profile. As noted from the graph 18, there is a central regional of surgical treatment 20, and surrounding tumor border zones 22. The malignant cells in the tumor border zone 22 may cause recurrence of the disease.

To prevent or at least mitigate this risk, certain embodiments of recurrence assessment system and method may be used to assess the tumor border zone 22 (regional recurrence) to better identify the region of surgical treatment 20. In one embodiment, the recurrence assessment method analyses the tumor zone (as e.g., indicated by a physician or other qualified personnel), and based on the resulting tumor zone analyses, determines whether malignant cells are present in the border zones 22. In one embodiment, the recurrence assessment method is primarily applied in a data fusion step. For instance, the data fusion step may use an ultrasound and histology image to detect secondary cancers. However, the recurrence assessment method may also be applied in other instances, such as biopsy guidance, ablation, etc.

Certain embodiments of a recurrence assessment system and method may be used to address one or more problems. One problem may involve residual malignant cells in a patient, or more succinctly, tumor recurrence. A typical problem is that physicians are focused on a main tumor, and for one or more reasons (e.g., due to high workload), the physician may miss the possible tumors surrounding the tumor. Accordingly, there is a need to ensure that all malignant cells have been removed during a surgical operation. Certain embodiments of a recurrence assessment system and method analyze the neighboring organs to, say, segmented tumor zones (e.g., as indicated by a physician) and apply a margin (e.g., 10% of the initial analysis) to the analysis zone containing the tumor to (e.g., automatically) analyze for possible cancerous tissue to ensure that quality of care is preserved. Another or alternative problem involves longitudinal screening. That is, certain embodiments of a recurrence assessment system and method may be implemented in conjunction with longitudinal screening of patients, after the surgical operation of removing the tumor, to predict the recurrence of malignant cells in the region that underwent the surgical operation.

Before proceeding with a description of certain embodiments of a recurrence assessment system and method, a preliminary discussion of image generation and image fusion that may be used in the disclosed embodiments of a recurrence assessment system and method may be helpful with regard to image synthesis and fusion of images. Within the field of diagnostics of human disease, a multitude of different devices may be used to provide the diagnostics of patient diseases. Within clinical diagnostics, there are commonly 3 device types for performance of diagnostics: 1. clinical/laboratory diagnostic equipment, including electrocardiographs and hematology analyzers; 2. Radiology diagnostic equipment, including Ultrasound (US), Magnetic Resonance Imaging (MRI) and other imaging equipment; and 3. Tissue diagnostic equipment, including pathology scanners or tissue processing systems.

Different device types may provide different information points, which may be used for diagnosing the patient. For instance, diagnostic imaging equipment like Ultrasound (US) is sufficiently accurate in imaging the general organ structure, but US is not sufficiently accurate to image cancer cells due at least in part to inherent resolution properties. Hence, a US device can reveal tumors that may be cancerous, but also have sufficient chances of missing these lesions due to associated technological complexities. MRI, on the other hand, is sufficiently accurate in analyzing the soft tissues of the patient, but is prone to artifacts/variations in the devices, as well as representing a costly procedure that tends to limit its use on a routine basis.

Pathology scanners are fairly accurate in analyzing the morphological characteristics of a tissues, but are highly dependent on which part of tissue is being taken for further analysis (e.g., if the affected cell is captured or not). Pathology scanners also provide slides of significant size, which are challenging to manage within clinical practice. As a non-limiting example, assuming a biopsy slide output of 1,600/day and an average of 2 GB/slide, 1 PB/year should be calculated if all scans are to be archived and used by a clinical institution, which combined with the diagnostic information, is a challenging task.

In many cases, for such complex diseases as cancer, infectious diseases, chronic diseases, inflammatory conditions, thyroid lesions, diseases involving sterile body cavities (e.g., peritoneal, pleural, and cerebrospinal), there is a need to use more than one modality. In many cases, radiology diagnostic equipment (diagnostic imaging modalities such as the secondary diagnostic imaging modalities) and tissue diagnostic equipment (pathological imaging modalities such as primary pathological imaging modalities) complement each other and provide complementary information points for clinicians to consider. However, in many cases there are challenges in using both of these equipment types in clinical practice.

For instance, the referring physician may refer the patient to have a radiological examination followed by a pathological examination. The referring physician (e.g., Radiation Oncologist) receives the two pieces of information (diagnostic radiological images and pathological images), yet this may leave many challenges on interpretation of the diseases, as the referring physician may not be an expert in radiology or pathology studies to be able to analyze the studies. Even for experts in the field like Radiologists and Pathologists, with the current complexity of technologies and diseases, there exists a challenge in analyzing the results of the studies. This challenge is especially the case if e.g., a Pathologist needs to analyze radiological images, which is frequent in the current clinical environment. To give an example in relation to cancer, the physicians may gather for Tumor Board meetings to discuss the patient's condition and determine a course of treatment. Yet, this is still a complicated procedure that takes a lot of time, and may be prone to errors. Furthermore, Tumor Board meetings are expensive and cannot be used routinely for e.g., screening purposes.

However, a combination of information/data from two different imaging modalities of two different imaging modality types is important for such complex diseases as cancer. The information contained in the pathology scanners may be fundamental to understand the morphology and pathology of the cancer treatment. Usually, a diagnostic exam is performed to understand the patient's anatomy and determine whether regions of cancer are present, which will subsequently help in performing the pathological examination. The diagnostic imaging scan may be done through a CT, MR or US modality, wherein a Radiologist evaluates the results to diagnose cancer cells. If a presence of cancer cells has been determined, then a follow-up pathology scan may be being performed. In some cases, the pathology scan is done even if no cancer cells have been spotted on the imaging modality, such as where there is a suspicion of a cancer in the patient. The pathological examination may be done through taking biopsy samples of a tissue of a patient, staining the tissue samples through e.g., Hematoxylin and Eosin (H&E) staining, and subsequent visualizing of the samples with a pathology scanner or associated workstation.

One challenge for the Pathologist and Interventional Radiologist is to understand the anatomy of the patient correctly for correctly performing the biopsy, as well as consequently correctly analyzing the pathology sample considering the patient anatomy. It would be apparent for the skilled practitioner, that to improve the diagnostic quality, the e.g., Pathologist or Interventional Radiologist performing the biopsy should consult the diagnostic imaging data to correctly determine the patient's anatomy. This may prove quite cumbersome, time-consuming, and prone to mistakes in the interpretation. To perform the pathology examinations, the Pathologist should define the boundary of the lesion or organ with lesions, which may create further mistakes of a human and/or technical nature. From the human side, the diagnostic imaging scans might be misinterpreted and the place of the cancer incorrectly identified. From the technical perspective, diagnostic image information and pathological image information has different information structure and the combination of information may be prone to mistakes. Yet, considering the valuable clinical information that is provided by both modalities, there is a clinical need to combine the information for more efficient diagnosis of complex diseases like cancer.

In view of the above-mentioned challenges, there is a need to combine information from two different imaging modalities of different modality types to assist the physicians in diagnosis of the tumor. As a non-limiting example, the first imaging modality may be of a Radiology diagnostic equipment type, such as Ultrasound (US) or Magnetic Resonance Imaging (MRI) equipment; and the second imaging modality may be of a tissue diagnostic equipment type, such as a digital pathology scanner. By combining the information from different imaging modality types, the quality of diagnosis of a patient and the clinical workflow may be improved, with possibly reduced costs to the clinical institution. Currently, there are no approaches used in clinical practice combining information from two different imaging modalities of two different modality types while preserving the information in both the modalities. Current approaches are limited to a combination of two imaging modalities from the same type. For instance, in radiation therapy treatment, a multi-modality simulation of radiological images (e.g., simulation of CT to MR data) is used.

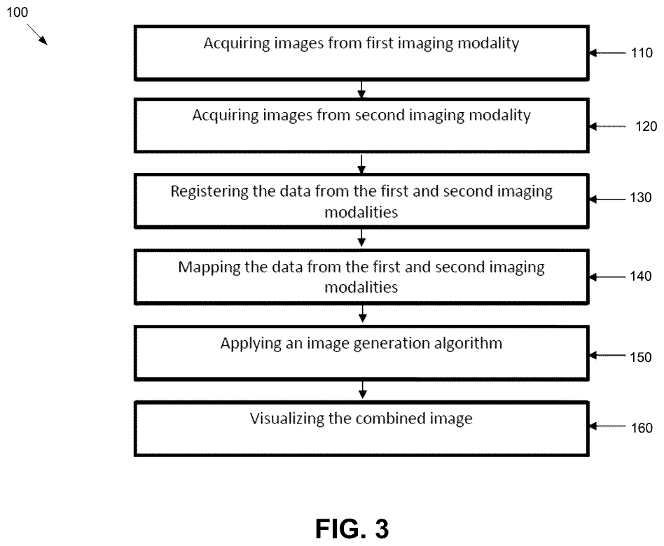

FIG. 3 schematically depicts an example image generation algorithm. In the following, a computer-implemented image generation method, or just an image-generation method 100, for generating combined diagnostic and pathology images is described. The method comprises the steps of: acquiring with a first imaging modality pathological image data 110 of a subject; acquiring with a second imaging modality diagnostic image data 120 of the subject; mapping 140 the pathological image data to the diagnostic image data; applying an image generation algorithm 150 in order to generate at least one combined diagnostic and pathology image based on the mapping of the data.

In some embodiments, the at least one combined image may be visualized for representation (step 160). Other ways in presenting the image exist. In some embodiments, there is an optional registration step 130 that is performed before the mapping step 140. One goal of the registration step is to increase the precision of the mapping algorithm and to reduce the number of errors.

Variations of the approach depicted in FIG. 3 may occur depending on the embodiment. Further details describing the approach of the method 100 generally shown in FIG. 3 is described below.

A combination of data from two different imaging modalities of different modality types, such as diagnostic and pathological imaging modalities, may be difficult to perform to maintain the advantageous information contained in both imaging modality types. One issue in combining data from two different imaging modality types is the different slice thicknesses of the modalities. For instance, the slice thickness of in-vivo radiology images is around 1.5 mm for MRI and 0.8 mm for CT. The determination of slice thickness for ultrasonography images is a more complicated task and depends on many factors like the depth of the imaging. However, the slice thickness of an Ultrasound machine still varies in the range from 0.1 to 2 mm for most applications. On the other hand, the slice thickness of images from a pathology scanner is around 5 μm. Comparing CT images with pathological images may yield a difference of around 1000:1. Hence, the images of the diagnostic modalities are not exactly overlapping or matching the appearance of gross pathology or histopathology due to such differences. Consequently, in the combining of images, valuable diagnostic information may be lost in the process.

Referring again to the (image generation) method 100 of FIG. 1, the method acquires data from a first pathological imaging modality 110 (e.g., digital pathology scanner) and acquires data from a second diagnostic imaging modality 120 of a radiological type (e.g., US, CT, MR). Then the image generation method 100 performs a mapping 140 of the pathological data towards the diagnostic data. The mapping may include registering 130 the data from the pathological data to the diagnostic data, or vice versa (i.e., from the diagnostic data to the pathological data). Finally, an image generation algorithm 150 is applied to the mapped data sets to generate a combined diagnostic imaging and pathology image based on the mapping of the data. As a final step, acquired data may be visualized 160. This method 100 enables the generation of images with combined diagnostic and pathological data.

It is to be understood that to correctly combine the data, first an image registration needs to be performed. Image registration within the context of the present disclosure may be defined as a process of aligning two or more images, wherein the images may be of the same imaging modality (e.g., US to US) or different modalities (e.g., US to pathological images), or both. Image registration may also be referred to as image fusion, matching or warping within the context of the present disclosure.

One goal for applying an image registration method is to find a transformation that best or at least suitably aligns the structures of interest in the input images of first imaging modality and second imaging modality types. Accurate registration of images is an important step for correctly preserving the information of the two different images and correctly aligning the images. The data from the diagnostic imaging modality can be in a DICOM (Digital Imaging and Communications in Medicine) format since it relates to diagnostic images, such as CT, US, MR, or others. Any of the algorithms used in the field in relation to DICOM image registration may be used. As a non-limiting example, the algorithms used for image registration of diagnostic images may be selected from the following types: intensity-based image registration type, spatial registration methods, time-series registration methods, extrinsic registration methods, intrinsic registration methods, landmark-based registration methods, segmentation-based registration methods, voxel property-based registration methods. In some embodiments, registration is synonymous to segmentation. For more information in relation to image registration techniques, reference is made to the document Image registration methods: a survey, by Barbara Zitová (https://www.sciencedirect.com/science/article/pii/S0262885603001379), incorporated by reference.

At least some of these methods may also be applied for the pathological images. Due to the nature of the pathological images, registration methods for pathological images may be selected from the following methods: intensity-based registration methods (e.g., normalized mutual information), feature-based registration methods (e.g., scalar-invariant feature transform), feature/intensity-based registration methods (e.g., Register Virtual Stack Slices, RVSS), or segmentation based methods (e.g., ASSAR). One possible reason for using these image registration methods is that the pathological images are usually stained, and the described methods allow for better registration for pathological images in view of the landmark points. Both elastic and non-elastic registration methods may be used.

The image registration techniques described herein may be intensity-based and/or feature based. In some embodiments, feature-based techniques may involve spatially transforming the source/moving image(-s) to align with the target image. The reference frame in the target image is stationary, while the other datasets are transformed to match to the target. Intensity-based methods described herein may involve comparing intensity patterns in images via correlation metrics, while feature-based methods find correspondence between image features such as points, lines, and contours. Intensity-based methods register entire images or sub-images like image regions. If sub-images are registered, centers of corresponding sub images may be treated as corresponding feature points. Feature-based methods establish a correspondence between several distinct points in an image. Both linear and elastic transformations may be used.

In some embodiments, the diagnostic images 120 are directly aligned and registered to pathological images 110. In some embodiments, first the diagnostic images are registered to each other (e.g., an US image is registered to another US image), the pathological images 110 are registered to other pathological images 110, followed by a registration from the pathological images 110 to diagnostic images 120. While one registration method may be used for both diagnostic and pathological images, it is to be understood that different registration methods may be used depending on the goal. Any combination of the methods described in the previous paragraph may be used. For instance, to align diagnostic images to other diagnostic images 120, spatial registration methods may be used, whereas for registering the pathological images 110 to each other, and then registering the pathological images 110 to diagnostic images 120, an intensity-based registration method may be used.

In some embodiments, the images may be pre-processed before the registration of the images is done. Applying a pre-processing algorithm may increase the alignment results. In some embodiments, the system displays the result of the registration of the images to the user. In this way, the user has the possibility of changing the results of the registration to achieve a better alignment of images. In some embodiments, annotation may be done by the registered pair of images (diagnostic to diagnostic, pathology to pathology, or diagnostic to pathology). In some embodiments, an image similarity metric may be used for comparing and correctly registering the diagnostic and pathology imaging modalities. The similarity metric may take the two image intensity values for a certain image and return a scalar value that describes how similar the images are to each other. Furthermore, in some embodiments, an optimizer may be used, wherein optimizer defines the methodology for minimizing or maximizing the similarity metric (e.g., absolutely, or in some embodiments, relatively).

In some embodiments, after performing the optional registration 130 of images, or during the process of registration, image mapping 140 is being performed. In mapping one image onto another image, a mechanism is used to match and find the corresponding spatial regions which have the same meaning between the source and the matching image. By doing so, the information in the images may be preserved and subsequently displayed in the image containing both radiological and pathological data. In one embodiment, image mapping is preferred, since the underlying diagnostic and pathological image data have different structures. Mapping 140 within the context of the present disclosure may involve mapping between spatial regions in the source, and matching images in a database. The mapped regions have similar semantics, which may improve preservation of data from the images. Image-based data integration may be useful for integrating data from various information modalities. In some embodiments, mapping of images may also be followed by image segmentation algorithms. Any existing image segmentation algorithms may be used, including: (1) manual delineation methods, (2) low-level segmentation methods, and/or (3) model-based segmentation methods. The document Medical Image Segmentation Techniques: An Overview, by E. A. Zanaty (https://www.researchgate.net/publication/294682473_Medical_Image_Segmentation_Techniques_An_Overview) is incorporated herein by reference. AI methods for segmentation may also be applied, including, for instance, contour-based segmentation methods, voxel-based segmentation methods, registration-based segmentation methods, fully convolutional networks (FCN's), U-net's, dilated convolutional networks, and others.

In one embodiment, mapping 140 of one image onto another image involves a mechanism to match and find the corresponding spatial regions with the same meaning between the source and the matching image. Image-based data integration may be useful for integrating data of various information structures. In some embodiments, fiducial points in diagnostic and pathological images 110, 120 may be determined, and image segmentation of fiducial points and the corresponding anatomical regions may be performed. This may help to further improve translation of points from the diagnostic images towards the pathological images.

The image generation algorithm 150 may be applied based on the registered and mapped images. Image generation as used herein has the same meaning as within the field of medical imaging: it is a process of synthesizing new medical images. The process of generating medical images 150 is described further below.

In one embodiment, the first pathological imaging modality 110 may refer to any modality suitable for analyzing tissue information, and providing information on the morphology of the tissues, organs or fluids, including gross, microscopic, immunologic, genetic and molecular imaging modalities to determine the presence of disease. In one embodiment, the pathological imaging modality is of a digital pathology type. Further, the second diagnostic imaging modality 120 may refer to any diagnostic imaging modality. Ultrasound (US) or High-Frequency Ultrasound (HFUS) modalities may be used. However, other imaging modalities are possible, where non-limiting examples include MRI, CT, PET/MR, PET/CT, SPECT, X-ray, CBCT, angiography, fluoroscopy and other imaging modalities.

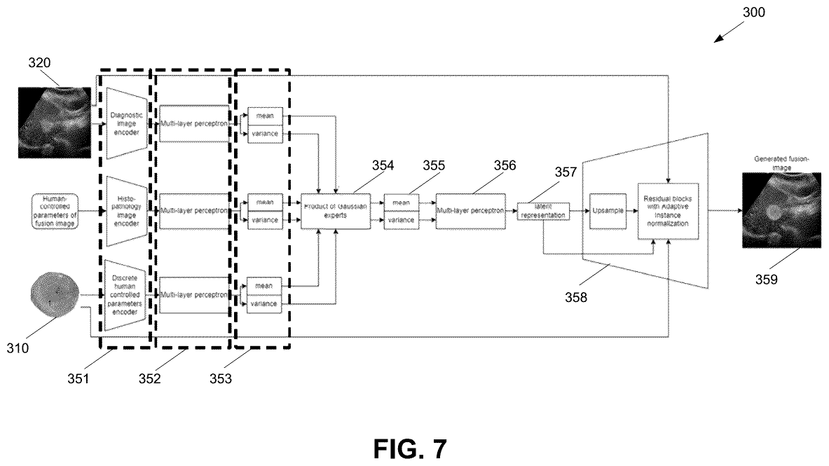

In some embodiments, the image generation algorithm is a Generative Adversarial Network (GAN) or a multi-conditional generative neural network (MC-GAN) type algorithm. In some embodiments, and with reference to FIG. 7, the image generation method is configured to: encode 351 the data with an encoder, apply 352 a multi-layer perceptron, calculate 353 the mean and variance, apply 354 a product-of-expert algorithm, calculate 355 the mean and variance, apply 356 a multi-layer perceptron, create 357 a latent representation, and decode 358 and generate 359 a combined image. Other variations of this algorithm are possible, for instance, omitting some of the steps depending on the goal.

Referring again to FIG. 1, in some embodiments, the pathological image data 110 and the diagnostic image data 120 are further mapped with a diagnostic image with a biopsy needle, wherein a further biopsy region extraction and applicational of a segmentation mask is performed.

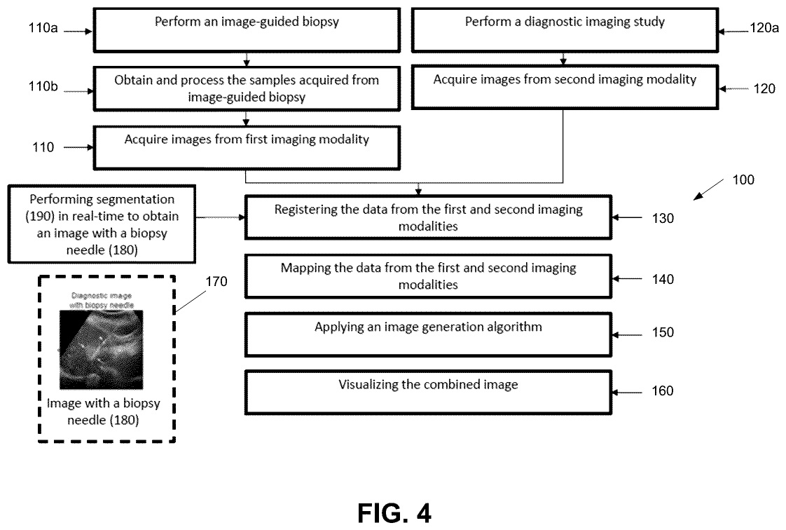

Referring to FIG. 4, shown is a system and method 100 as viewed from a clinical perspective. In getting the required data, the user usually performs an image-guided biopsy 110a. In performing the image-guided biopsy 110a), the user obtains tissue samples 110b, which are then processed. Processing” within the context of the present disclosure is understood as the standard handling of tissue samples used for pathological analysis. For instance, the biopsied tissue is put into small containers (cassettes), processing of samples for fixating the tissue to the cassette is done (e.g., in hot paraffin wax), cut into thin slices with a microtome, the specimens put on glass slides, and dipped into a series of stains or dyes to change the color of the tissue (by using e.g., H&E staining). The obtained images are then stored in a database, which are further acquired by the system 100 for further analysis. Performing a diagnostic imaging study 120a within the context of the present embodiment follows conventional procedure of obtaining diagnostic images. For instance, a physician may examine a patient with an ultrasound probe in an examination room, and then the resulting images are stored on a US device, and later may be transmitted to a database. It is to be understood, that the pathological images and diagnostic US images are given as a non-limiting representative example, and other combination of images (e.g., cytology and MR images) are possible, or combination of modalities (e.g., US and MR modality with histopathology scanners) is possible.

The diagnostic images 120 are acquired from e.g., the database, or the US device, for further analysis. When the system 100 acquires the images 110 from the first pathological image modality and the images 120 from the second diagnostic image modality, the system 100 registers 130 the data from the first and second imaging modalities, maps 140 the data from the first and the second imaging modality, applies 150 an image generation algorithm, and visualizes 160 the resulting image.

In some embodiments, the images 110 from the first imaging modality and the images 120 from the second imaging modality are acquired simultaneously. The biopsy needle navigation may be obtained by e.g., a guided fusion biopsy system, like the Uronav® system of Philips. The Uronav® system fuses pre-biopsy MR images of the prostate with ultrasound-guided biopsy images in real time, which enables an improvement to the delineation of the prostate and suspicious lesions, as well as a clear visualization of the biopsy needle path.

To correctly perform the image-guided biopsy procedure 110a, a biopsy localization processor and corresponding method of biopsy localization 170 may be used. The biopsy region localization processor 170 may be based on a Convolutional Neural Network (CNN), such as a lightweight convolutional neural network. The CNN performs semantic segmentation in real-time, and shows the result on a diagnostic display, such as the display of an ultrasound machine. The convolutional neural network first down-samples the input diagnostic images from the second diagnostic imaging modality with trained convolution-based down-sampling layers. There are two options when the down-sampling is performed: 1. The down-sampled data can be used for fusing the images of the second diagnostic imaging modality with the biopsy needle 180. 2. A further global feature extraction is performed to reduce the dimensionality of the data, whereas afterwards an image fusion as the one described in option 1 is performed. By using the second option, it is possible to apply classification of pixels on a hierarchical level.

Furthermore, real-time image segmentation 190 may be applied. The real-time segmentation 190 may be of a semantic image segmentation type. The real-time image segmentation 190 is configured to focus on three sections of the image in the segmentation process: the biopsy needle, the one or more lesions, and the image background. However, other focus points are possible. For instance, the algorithm may focus on one or more fiducials, which may be identified by the user or an algorithm. A diagnostic image with a biopsy needle is generated as an output 180.

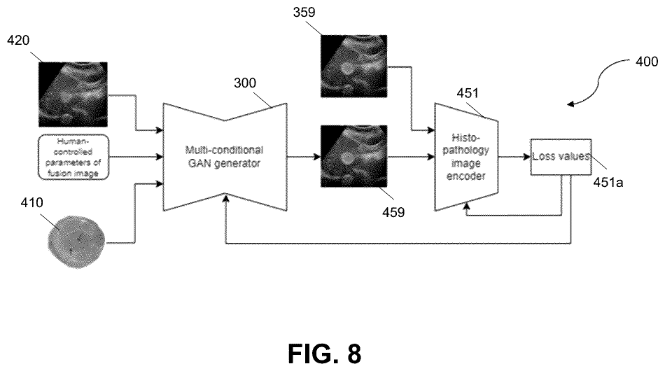

To further increase the precision of the algorithm, the CNN network may be trained on one or more data sets. In an embodiment, training of the CNN network may be performed on the dataset that contains diagnostic images from the second diagnostic imaging modality, with the biopsy needle and associated data (e.g., fiducial associated with the biopsy needle) as inputs for the model, and wherein based on the inputs and the CNN algorithm, the segmentation is performed. As an example, the segmentation of the biopsy needle may be performed. Training of the data may be conducted both in a supervised manner and non-supervised manner. The training may be done in a supervised manner. A non-limiting example of a training method is shown in FIG. 8. As a representative example, the output may include a diagnostic image with biopsy image and respective segmentation showing biopsy localization.

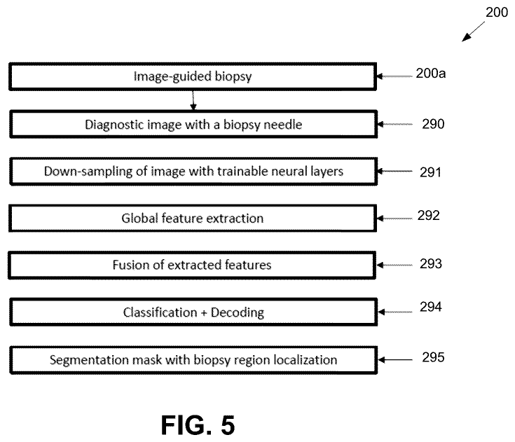

FIG. 5 illustrates a non-limiting example of an image segmentation algorithm 200. For instance, FIG. 5 shows that an image-guided biopsy 200a is performed, wherein by performing the steps described previously, a diagnostic image with a biopsy needle is obtained 290. After performing the down-sampling 291 of the image with trainable neural network layers in a form of fully connected layers or convolutional layers, the CNN network performs global feature extraction 292. Subsequently, down-sampled image representations before (291) and after feature extraction (292) are fused 293. After the fusion of images is performed, a classifier and decoder may be applied 294 to classify the images, e.g., to classify the images on the diagnostic images. After the classification is performed, a segmentation mask with a biopsy region localization is generated 295. In some embodiments, the generated localization mask may be used for combination of images.

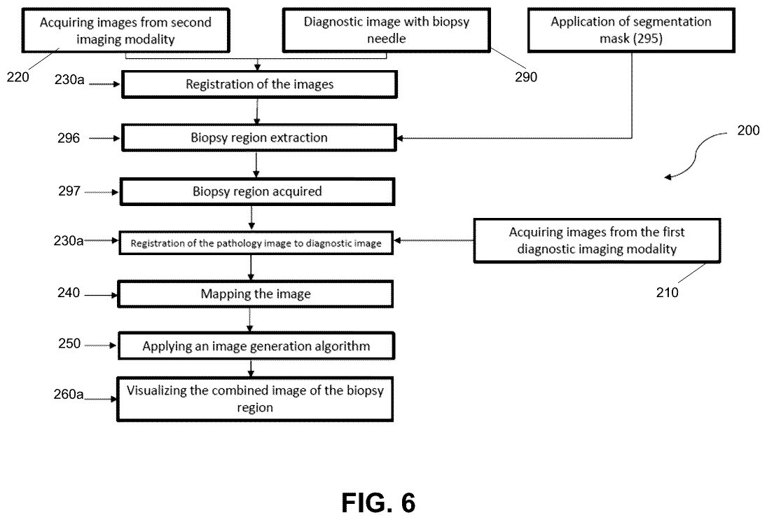

FIG. 6 illustrates a method 200 whereby the segmentation mask may be used for further improving the generation of images from the first and second diagnostic image modalities 210, 220. FIG. 6 describes acquiring two sets of data, namely acquiring images 220 from the second diagnostic imaging modality (e.g., US), and acquiring diagnostic images with a biopsy needle 290. As a non-limiting example, the diagnostic images with a biopsy needle 290 may be pre-operative, intra-operative, or combination of the two image types. When the images 220, 290 are obtained, they are registered 230a to each other by any of the methods described herein. The notation “230a” instead of “230” is used to indicate that, in this case, the image pair 220, 290 is registered. For the original pair of images 210, 220, the notation “230” is used. When the images are registered, a biopsy extraction 296 may be performed. Extraction refers to identification of a region of interest, i.e., the region of interest, where the biopsy will be likely/is performed. Biopsy extraction 296 may refer to any means performed in the art to emphasize the extracted region. For instance, the biopsy extraction region may be delineated, may be segmented, mapped out, emphasized (e.g., highlighted), delimited, outlined, or identified in any other way that is suitable in the field of image registration and image visualization.

One goal of the biopsy extraction 296 is to identify the region of interest where the biopsy is performed. The biopsy extraction 296 may also refer to identification of other points of interest in relation to the biopsy extraction, e.g., identification of lesions or fiducials. After or during the biopsy extraction 296, the system or device and the associated computer-implemented method/algorithm may apply a segmentation mask 295 to the biopsy region, i.e., the region of interest associated with the biopsy procedure in the diagnostic image. Segmentation mask 295 may be of the type described in relation to FIG. 5. However, other segmentation mask approaches are possible. In an embodiment, the segmentation mask 295 is of type that is suitable for segmentation. A non-limiting example of such a mask may be R-CNN. Application of the segmentation mask 295 may be done after the biopsy region extraction step 296 is performed, or while the step 296 is being performed. In some embodiments, application of the segmentation mask 295 is optional. When the biopsy region extraction 296 and the application of the segmentation mask 295 is performed, the region of the biopsy is acquired 297.

By acquiring the biopsy region 297, a sequence of steps is meant for making the image available for further registration, e.g., storing the image on a (Random-Access Memory) RAM/storage device, like hard-disk drive/transmitting to the cloud, and/or converting the image to a specified data format. When the biopsy region is acquired 297, the system may acquire the images from the first diagnostic imaging modality 210. The images from the first imaging modality may contain e.g., pathological images. In some embodiments, images from the first diagnostic imaging modality may be acquired from the previous examinations, e.g., from the previous biopsy studies. By incorporating the images from the previous biopsy studies, there is a possibility of improving the clinical practice, in e.g., making a more precise determination of the affected regions with e.g., cancer, so a more accurate biopsy can be taken. This is important, taking into account the non-homogeneity of the cancer cells, and hence such a structure enables taking, more precisely, the biopsy samples from multiple sections of the affected region. This could be useful for both screening and diagnosis purposes. In some embodiments, the pathological data may be received from the pathological studies done in real-time. Upon receiving the data from the first imaging modality 210, and the registered data 230a from the second imaging modality 220 and the diagnostic image with biopsy needle, a further registration 230 of the registered data 230a and the data from the first imaging modality 210 is performed. The registration may be of any type previously described. Upon registration 230, a mapping may be performed 240, along with an application of an image generation algorithm 250 and visualization of the combined image 260a. The notation “260a” is used to specify that this image also contains data from the diagnostic image with a biopsy needle 290, however the notation “260a” is otherwise similar to the notation “260”.

The following example explains the clinical perspective of having such a method 200 more in-detail. Once a biopsy sample is extracted from the patient, it is examined with a digital pathology scanner or other histopathology equipment, which results in a pathology image (i.e., image from the first imaging modality 210). A previously acquired diagnostic image from the first imaging modality 220, the diagnostic image with biopsy needle 290, and the acquired image from the first imaging modality 210 are registered in step 230a. Registering the images from the first imaging modality 210 (e.g., histopathologic image) to the registered images from the second imaging modality 220 and the diagnostic image with a biopsy needle 290 is a challenging task. This may be due to the following challenges:

1. Preparation of a biological sample for pathological/histopathological examination may introduce artifacts. Non-limiting examples of artifacts may include deformations, shrinkages, and tissue ripping. By correctly registering the images, at least some of these artifacts may at least partly be avoided. For instance, deformation artifacts and shrinkage artifacts may be alleviated by correctly registering the images, while other artifacts, such as tissue ripping artifacts, may be addressed by correctly applying the image generation algorithm 260 (in other words correctly synthesizing the images).

2. Lesion appearance in diagnostic images, e.g., the ones obtained from the second diagnostic imaging modality 220, may drastically differ from the lesion observed in a pathological image, e.g., the images acquired from the first pathological imaging modality 210. There are many reasons for that, e.g., different slice thicknesses of modalities, staining involved in pathological images, different image formats, etc. To address this, it may be useful to have additional information, such as the extracted biopsy region 296 to alleviate this challenge.

It is to be understood that the registered segmentation mask may be used to extract biopsy region from the diagnostic image from the second diagnostic imaging modality 220. It is to be further understood that the output of the image registration 230a may include pairwise registered diagnostic 220 and pathological 210 images, wherein the pathological images 210 may contain artifacts that image registration could not remove (e.g., tissue ripping artifacts). Image registration 230a may be performed by improving (e.g., optimizing) affine and deformable transforms using a registration based on a multi-resolution pyramid with three layers. The image registration may be done either on a system or device implementing the method 200, or any other suitable system or device, such as the workstation of a physician containing the images.

Further, examples of image generation algorithms 160, 260 that may be used in previous embodiments 100, 200 are described. The image generation algorithms 160, 260 may be selected from any type of image generation algorithm, including: image fusion algorithm, existing image transformation, image regeneration, or any other methods of combining information from one image to the second image. In an embodiment, the image generation algorithms 160, 260 are of an image fusion type. The image fusion algorithm may be based on Machine Learning, such as a GAN algorithm. A non-limiting example is given below.

In a non-limiting example, the image generation algorithm may be based on multi-conditional generative neural network (MC-GAN). The technical details of such an algorithm are incorporated by reference from Huang, Xun, et al. “Multimodal conditional image synthesis with product-of-experts gans.” arXiv preprint arXiv: 2112.05130 (2021). In one embodiment, the image generation method may be based on generative adversarial neural network, which acquires the diagnostic image from the second imaging modality diagnostic image 120, 220 and the diagnostic pathology image from the first imaging modality 110, 210. It is to be understood that in some embodiments, the diagnostic image with the biopsy needle 290 or the registered image 230a may be used as input for the algorithm. In some embodiments, the user may change the parameters of the images and input additional parameters for the MC-GAN algorithm, which is referred to as “human-controlled parameters”. This means that the MC-GAN may be applied to any of the steps, e.g., in relation to mapping, registration of images, but particularly the MC-GAN algorithm may be applied for generation of images (250). The following non-limiting examples are given.

A first example is generating a fusion image provided with all the input conditions (images from the first and second imaging modalities 110, 120, 210, 220), including optional human-controlled parameters. The optional human-controlled parameters may for instance map, define or otherwise represent whether the at least part of the tissue in the combined image should represent information coming from the first diagnostic image modality 110, 210. a second example is generating a fusion image provided only with diagnostic image information, i.e., the information coming from second diagnostic image modality 120, 220 alone, or in combination with the information from the diagnostic image with biopsy needle 290. In this case the trained MC-GAN may be used in image-to-image translation of the images.

An example of such a MC-GAN algorithm is provided with respect to FIG. 7. The example in relation to FIG. 7 will be described with respect to one embodiment 300, but it is to be understood that the same principles may apply to embodiments 100, 200. The MC-GAN described in FIG. 7 acquires data from the first pathological imaging modality 310 and second diagnostic imaging modality 320, wherein the input data may also contain human-controlled parameters of fusion of images. These inputs are referred to herein as “input channels”. For instance, an additional discrete parametrized vector that defines a fusion image appearance may be considered. Then the MC-GAN algorithm begins the analysis. The generator (not shown) may be trained to learn to create simulated/pseudo-data by e.g., incorporating feedback from the user-controlled parameters. For instance, the user may define a specific weight, and the generator then learns the weights. Further, an encoder 351 encodes the data, wherein the decoder 358 tries to reconstruct the data back using the internal representations and the learned weights. As a non-limiting example, a “product-of-expert” may be used, wherein the encoder is projecting input conditions into the joint conditional latent space. Other encoder types may be used, for instance Variational Autoencoders (VAE) or Vector Quantized VAE (VQ-VAE).

There may be different possibilities for encoding the images. For instance, when only a single condition (i.e., only the images from the second imaging modality) is passed through the encoder 351, latent space distribution associated with the encoder is getting wider, which means the possible generated images by the image generation algorithm may deviate from the actual images. However, since the latent space distribution is smaller, the combined, fused or otherwise synthesized images are generated much faster. The use case of such an image may be for screening purposes, where the precision is not critical, but speed is much more valued. On the other hand, for complex surgery, navigation for biopsy, and other complex clinical procedures, the system may consider information from all of the sources. However, when all the conditions (diagnostic image 310, 320, 390, as well as user input) are provided, the number of constraints increases, and the space of possible outputted fused images shrinks. In other words, the generated fused images will contain more details, and increase the size of the images. Depending on the goal and available storage data, different approaches may be used.

In step 352, a multi-layer perceptron is applied. In step 353, the mean and variance are calculated. Within the current invention, usage of mean and variance in step 353 is configured to describe data point(s) in a latent space. A practical example is as follows: in each input channel, each encoder may “compress” and project input conditions (pathological images 310 and diagnostic images 320) to the feature space, which as herein understood, may mean that instead of representation of an image in a form of pixels in the latent space (e.g., 4096×4096 pixels), each condition may be represented with a feature vector (e.g., 512×1 vector). As understood herein, projection and sampling may mean the standard meaning within the field. For instance, normal distribution around each point of the input data in the latent space may be calculated, and the mean μ(x)) and σ(x) may be the parameters of this distribution. These parameters may be different for each point.

In some embodiments, there are three pairs of encoders that analyze the images from the input channels. In some embodiments, there is one encoder, which analyzes the images from the input channels and human-input. However, there may be other numbers of encoders in some embodiments. The output of the encoder 351 with additional operations 352, 353 is referred to herein as latent space distribution. In the step 354 and in one embodiment, Product of Experts, PoE (also called product of Gaussian Experts) is applied. Product of experts (PoE) is a machine learning technique, which models a probability distribution by combining the output from several distributions, i.e. in relation to diagnostic images 310, 320, and human input. Other parametric model types (e.g., mixture of Gaussians, generalized product of experts) may be used. The PoE in step 354 may weight mean and variance of distributions in step 355 from the input parameters. The resulting mean and variance values may be passed to a multi-layer perceptron that, in step 356, is used to create a vector-form latent representation 357 of the desired combined image. This latent representation 357 may be passed to the decoder 358 of the generator.

In some embodiments, the multi-layer perceptron 352, 356 (e.g., in a form of a fully connected neural network, convolutional neural network, or attention based neural network) may be used as a mapping network. The multi-layer perceptron (352, 356) enables disentanglement of latent feature space, which makes the conditioning of the whole neural network more controllable. Disentangling of the latent space refers to the fact that the input channels do not affect each other in latent space. Mean and variance in steps 352, 356 may describe the data points in the latent space. In some embodiments, the multi-layer perceptrons are the same. In some embodiments, the multi-layer perceptrons 352, 356 are different. For instance, the multi-layer perceptron 356 may be more sophisticated as the latent space is more complicated and includes conditions of pathological 310 and diagnostic 320 images.

The decoder 358 comprises of a sequence of up-sampling layers and residual blocks with an adaptive instance normalization. The adaptive instance normalization layer accepts a scaled (e.g., processed) diagnostic image, a scaled (e.g., processed) pathology image, and a latent representation vector to form a desired output of the network by transferring important features of the input conditions. In some embodiments, the decoder 358 may further include normalization algorithms, which normalize the expected result. One such example is Adaptive Instance Normalization, which is a normalization method that aligns the mean and variance of the content features with those of the style features. However, other normalization methods may be used. Finally, in step 359, the combined image is generated. However, it is to be understood that different variations of this algorithm are possible, depending on the goal at hand. For instance, the data from images 310 and 320 may be directly fed to the decoder 358 to have a very simplified version of the algorithm that can e.g., be used for screening purposes.

The MC-GAN of the current application may have the following structure. For instance, and referring to FIGS. 7-8, the encoders 351, 451 may contain convolutional layers with skip-connections. The multi-layer perceptrons 352, 356 may contain four fully connected layers. In some embodiments, the connected layers may further comprise a hidden dimension four times smaller than an input data dimensionality. The latent space may be represented with a vector space with e.g., 512 dimensions. Other dimensions may be possible. The decoder 358 may contain residual blocks with convolutional layer(s). Each block may contain four convolutional layers with the number of filters four times smaller than the input channel size. The kernel size among the convolutional layers may be set to three (3). In some embodiments, the activation function layers applied in encoders, multi-layer perceptrons and decoders are “leaky ReLU” (rectified linear units) with a slope of 0.2. The skilled person would realize that other implementations may be possible.

Existing MC-GAN's, like the one presented in Zhu Zhang, Jianxin Ma, Chang Zhou, Rui Men, Zhikang Li, Ming Ding, Jie Tang, Jingren Zhou, and Hongxia Yang. M6-UFC: Unifying multi-modal controls for conditional image synthesis or Huang, Xun, et al. “Multimodal conditional image synthesis with product-of-experts gans.” arXiv preprint arXiv: 2112.05130 (2021) is trained in generation output from a single modality, and designed to unify multi-modal controls. This framework is not designed to generate multi-modal images, nor it is designed generate diagnostic images. The current framework is trained to fuse input images. The input conditional images from two imaging modalities are preserved and present in the output image, while in the mentioned existing MC-GANs, the input images are used to create new images with style from the input ones. The existing MC-GANs are inapplicable to diagnostic images since the images need to preserve a lot of information from the two modalities, and the existing MC-GANs are sketching-out the information. While the original GAN accepts a textual description, segmentation mask, sketch, and style-reference image to produce an image that never existed before, the MC-GAN disclosed herein fuses/generates existing images of two different diagnostic imaging modalities and further aligns the images to preserve the diagnostic information. Hence, since a smaller number of conditions are used, the training of the model is simpler and more precise. Also, the number of input encoders is reduced. Thus, the overall complexity of the MC-GAN is decreased comparing to the original GAN.

It is to be understood that the algorithm/method 300 described in FIG. 7 is a non-limiting example, and other variations of this algorithm may be possible.

The methods/algorithms described here may also be trained. A non-limiting example of training the MC-GAN algorithm/model 400 is described in FIG. 8. For simplicity, the training of the model is described with respect to a separate embodiment 400, but it is to be understood that this model may apply also to embodiments 100 and 200.

The training of the model uses the input of the diagnostic images 420 from the first diagnostic imaging modality, both the diagnostic images 420 from the second diagnostic imaging modalities and images 410 from the first pathological imaging modalities. In some embodiments, human input may also be considered. Then, the MC-GAN algorithm 300 may be applied, like the one described in association with FIG. 7. This generates the combined images 459, similar to the images in respect to the embodiment 300, i.e., images 359. Optionally, the model 400 may use the combined images from previous steps 359 for training of images. An encoder 451 is applied at the next step. The encoder 351 is similar to the encoder 351 described in reference to the embodiment 300. Within the encoder 451, algorithms for improving (e.g., optimization) the encoder functioning may be used. For instance, Kullback-Leibler divergence may be calculated from a prior distribution to a conditional latent distribution, which aims to further improve (e.g., optimize) the encoder. In the next step 451a, the loss values are calculated. The loss values may feed back to the encoder 451 and/or the MC-GAN algorithm 300 for training of images. The loss values may be of three (3) principal types: image contrastive loss, conditional contrastive loss, and adversarial loss. When the loss values calculation is being referred to herein, one or more of these loss types are referred to. Further a short description of the different loss types is presented. Image contrastive loss maximizes the similarity between real and random fake images synthesized based on the corresponding conditional inputs. Conditional contrastive loss aims to better align synthesized images with the corresponding conditions. Adversarial loss is measuring how realistic is the generated image from the discriminator point of view. When a sufficiently good result is achieved, the GAN network stops the training and generates the final result. The training stops once the loss curves of the generator and discriminator achieve a plateau, and the metrics calculated on the validation set are not improving anymore with each subsequent epoch of training. The generated final result includes combined image 459.

The training may be based on the following non-limiting implementation example. In a non-limiting example, the current method is trained based on the Adam optimization technique. The skilled person would know that Adam is an algorithm for first-order gradient-based optimization of stochastic objective functions, based on adaptive estimates of lower-order moments. Other algorithms may be possible within the context of the present application: AdaDelta, Adagrad, Nesterov accelerated gradient, and others.

The Adam optimization technique with parameters β1=0 and β2=0.99 may be used to train the MC-GAN. The weights of the generator at the end of training are defined by an exponential moving average of its weights during training. Dropout of input data modalities with a 50% rate is applied during training to make the MC-GAN more stable to the missing input conditions. Learning rate scheduling is applied with weights' rebalancing with a decay factor equal to 0.99 (weight decay method). Early stopping in a form of metrics and losses monitoring is applied to prevent MC-GAN from overfitting. The minimum number of training iterations is set to 1000 epochs with minimal batch size equal to 4 images. Other variations within the context of the present application may be possible.

The methods 100, 200 and the associated MC-GAN models 300, 400 may work in two or more modes. The first mode may be the image mapping mode that includes all the components shown in FIG. 3. The second mode may be an image-to-image translation mode where the trained MC-GAN network may be used. In other words, the algorithms 100, 200 may be AI (Artificial Intelligence) and non-AI based.

The image mapping mode may be of a) Asynchronous image fusion based on image mapping; b) Synchronous image fusion based on image-to-image translation. Other modes are possible.

The first mode, i.e., the image mapping mode, may be asynchronous since it may require acquiring diagnostic images 120, 220 first, then conducting image-guided biopsy 110a, 220a with biopsy region extraction 296. Furthermore, performing the image registration 230a can be done with sequential fusion-image synthesis. Providing two conditions (diagnostic images 120, 220 and pathological images 110, 210) may impose additional restrictions and make the synthesis task less ill-posed. As a result, detailed information-enriched fusion-image is generated. The outcome may be used by a physician as a support for medical decision making. This mode may be deployed on the diagnostic device (e.g., US) or in a separate workstation.

The second mode allows synchronous image-to-image translation in real time. The trained model may be deployed directly on a diagnostic device, which is capturing the diagnostic images 120, 220. These images are passed through the generator which synthesizes the pathological overlay on top of the diagnostic images 120, 220. This mode may be faster than the first described mode. However, the speed of operation and the simplicity of use allow this mode to be used for high-throughput screening, providing physicians with additional information about probable morphology of tissues in a diagnostic image in real time.

As would be apparent for the skilled person, the application of GAN's or MC-GAN's to generation of a synthesized image is one of the insights of the present application. For instance the application of the GAN/MC-GAN to generation of images from two imaging modalities is not apparent for the skilled person. The existing methods, such as multi-modality image simulation used for radiation therapy planning, use the imaging modalities from the same modality type, e.g., CT and MR.

In an embodiment, the first pathological imaging modality is of pathological or histopathological type. As described herein, “pathological imaging modality” and “pathological images” are umbrella terms combining different images that contain some morphological information from a patient. These images can include, but are not limited to pathological images, histopathological images, and other images containing cell morphology information. As a representative example, the first diagnostic imaging modality may be of microscope slide scanner type (also known as digital pathology or digital histology scanner). In general, the first pathological imaging modality may include any scanner that is used for analysis of pathological images, such as histopathology scanner, histology scanner, pathology scanner, digital pathology scanner, microscope, or any other scanner that may be used for analysis and representation of the tissue information and analysis of pathology slides.

The second diagnostic imaging modality may be an ultrasound or High Frequency Ultrasound (HFUS) modality type. However, other modalities may be used, including CT, High Intensity Focused Ultrasound (HIFU), MRI, Positron Emission Tomography (PET), Single Photon Emission Computed Tomography (SPECT), PET/MR, PET/CT, X-ray imaging, SPECT/CT, SPECT/MR, and others.

Reference herein to first pathological imaging modality and second diagnostic imaging modality may refer also to the images generated from such modalities, and both may be used interchangeably. Other variations in naming the “first pathological imaging modality” and “second diagnostic imaging modality” may exist. For instance, first and second imaging modalities, pathological modality and imaging modality, etc. But essentially these are synonyms, which will be apparent for the skilled person.

Registering of images from the first and second imaging modalities may involve image registering/transforming sets of data for each of the first and second imaging modalities into one coordinate system. Mapping of images may involve e.g., translating one set of images to another set of images (further details would be given below). After or during the registration/mapping, an image generation algorithm might be applied. The image generation algorithm is configured to generate a combined image containing registered histopathological image data and registered diagnostic image data. Any image generation algorithms, like image fusion algorithms, image-to-image translation algorithm, synthesizing images and others can be used. Visualization of images may involve a process of converting/rendering pixels/voxels from the mapped images into 2D/3D graphical representation. Consequently, an image containing both information from a first pathological imaging modality (e.g., histopathology scanner) and a second diagnostic imaging modality (e.g., US or HFUS) can be obtained.

In some embodiments, the image generation method and associated device is configured to generate synthetic images containing both diagnostic image and pathological image information. It is to be understood that “generating the synthetic images” or “generating a combined image” are used as examples, and other ways of combining images can be used. For instance, image fusion through asynchronous image combination, image fusion through synchronous image combination, and other methods existing in the field may be used. It is to be understood that the combined image may be a synthetic, fused or any other image type able to contain information from both the first and second imaging modalities.

As described herein, the combined image may be referred to, without limitation, as “enhanced histopathological image”. It is to be understood that the data acquired by first and second imaging modalities may be acquired both synchronously, i.e., in parallel at the same point in time, and asynchronously, i.e., at different points in time. It is to be understood that the steps of registering and planning can also be applied synchronously and asynchronously.

In some embodiments, a Neural Network might be used for generation of the combined image containing both diagnostic imaging and pathology imaging data. In an embodiment, the Neural Network algorithm is of a Generative Adversarial Network (GAN) algorithm type. A non-limiting example of a GAN algorithm is a multi-conditional generative neural network (MC-GAN). Other types of ML/NN algorithms can be used (i.e., not limited to the GAN algorithms).

In some embodiments, an image generation method, wherein the image generation algorithm is a Generative Adversarial Network (GAN) or a multi-conditional generative neural network (MC-GAN) type algorithm is disclosed. In some embodiments, the image generation method is disclosed, wherein the algorithm is configured to: encode the data with an encoder, apply a multi-layer perceptron, calculate the mean and variance, apply a product-of-expert algorithm, calculate the mean and variance, apply a multi-layer perceptron, create a latent representation, and decode and generate the combined image. Other variations of this algorithm are possible, for instance, omitting some of the steps, depending on the goal at hand.

In some embodiments, an image generation algorithm is disclosed, wherein the pathological image data and the diagnostic image data are further mapped with a diagnostic image with a biopsy needle, wherein a further biopsy region extraction and applicational of segmentation mask is performed.

In some embodiments, a further image-to-image (I2I) algorithm is applied. The I2I algorithm is configured to map the registered histopathological image to the diagnostic image data. Furthermore, the image generation algorithm, such as the GAN algorithm, may be used for image-to-image translations. In some embodiments, by using both a GAN and I2I algorithm, the precision of the mapping can be increased. The image generation algorithm may be configured to learn and synthesize the pathological representations covering the whole or part of tissue in the diagnostic image data. The mapping may include mapping contours of a part identified as pathological in the pathological image data to the diagnostic image data, or vice-versa.

In other words, in some instances, the image generation algorithm may be configured to identify and synthesize image parts, like a contour, on the image generation algorithm or the whole image. A combination of both generation of parts and general images can be used. By “image parts” or “biopsy region extraction” region it is understood that a specific part of an image is identified and synthesized on the diagnostic image data. This would allow a specific focus on regions of interest. One non-limiting example to apply this algorithm is to map the boundaries and/or pixels from the pathological image data to diagnostic image data, for instance, mapping a tumor from a pathological image data to a diagnostic image data.

In some embodiments, an image segmentation algorithm is applied, which is configured to segment the tissues from the histopathologic image data to diagnostic image data. The image generation algorithm may be further configured to determine the similarity of the pathological image data and the diagnostic image data. The segmented image data may be used as input for the image generation algorithm, and the image generation algorithm may be further configured to determine the similarity of histopathological and diagnostic image data. This may be based on the information from the segmented image. In some embodiments, the image generation method may be used, wherein the segmented image data is being used as input for the image generation algorithm, and the image generation algorithm is further configured to determine the similarity of histopathological and diagnostic image data.

In some embodiments, the method further includes mapping and/or translating regular shapes to irregular shapes from the pathological image data and the diagnostic image data. The image generation algorithm may be further configured to map and/or translate regular shapes in the first set of image data to irregular set of image data in a second set of image data. For instance, the pathological image data may contain irregular cancer shapes, which may be mapped towards regular organ shapes in the diagnostic images to enhance the image. One practical way to determine the similarity may be to use standard deviations in both the diagnostic image data and pathological image data and compare the two, which may increase the precision of the algorithm. In some embodiments, an image generation method is described, wherein the method further includes mapping and/or translating regular shapes to irregular shapes from the pathological image data and the diagnostic image data.

The diagnostic imaging modality may be selected from any or combination of: Ultrasonography (US) image, High Frequency Ultrasound (HFUS) image, Magnetic Resonance (MRI) image, Computer Tomography (CT) image. In an embodiment, HFUS or US modality is used.

In some embodiments, a mapping of histopathological image to diagnostic images is achieved in the range of 20:1, preferably 10:1, even more preferably 1:1. In an embodiment, it is possible to achieve a 1:1 mapping between the diagnostic imaging data and the histopathological imaging data. The algorithm can be further configured to be trained on the histopathological data and/or the diagnostic imaging data to produce better mapping of the algorithms based on the data deployed. In some embodiments, a region of interest of a nodule is determined. The determination may be automatic by the image generation algorithm or manual based on the collected user input.

A system for generating synthetic images from at least two imaging modalities is disclosed comprising at least two imaging modalities. The first imaging modality may be selected from the following modalities: a microscope scanner, a histopathology scanner, digital pathology scanner. The second imaging modality may be selected from the following modalities: Ultrasound (US), High-Frequency Ultrasound (HFUS), Computer Tomography (CT), Magnetic Resonance Imaging (MRI). In an embodiment, the combination includes digital pathology scanner and HFUS/US modalities.

In some embodiments, a cloud communication media, such as a cloud storage, can be used with the described system to transmit the data. Cloud communication media is not limiting in any way and could include any of: cloud storage, data lakes, data ponds, and other cloud communication and storage media. The cloud communication media/cloud storage represents the node in the communication link that links hospital nodes like slide scanners, enterprise software, diagnostic imaging modalities, PACS system or other nodes. The cloud communication media/cloud storage represents the cloud software servers with the related programs that may be able to obtain and store the data from the e.g., hospitals.

In some examples, a system for storing the data is described. The system for storing the data could store both diagnostic images, pathological images, or combined images. In some examples, the system can perform compression of images. Any type of compression algorithms known in relation to diagnostic or pathological images can be used. In some examples, the generated combined image may be transmitted to a Tumor Board system, or displayed to a Radiological/Pathological workstation, or present in real-time.

Having described some example embodiments for the fusion of images and image generation which may be used in some embodiments, attention is now redirected to further explanation of the recurrence assessment system and method. As explained above, certain embodiments of recurrence assessment system and method are described in the context of solutions to one or more problems. One solution addresses a first problem of residual malignant cell detection via real-time analysis of a tumor border zone (e.g., tumor border zone 22, FIG. 2) with a non-invasive imaging modality (e.g., US/CT/MR) that is used to extend or out-paint (e.g., through prediction) a histopathological image in the region of interest and predict a risk of a disease reoccurrence. For instance, certain embodiments of the recurrence assessment system and method receive a histopathological image of either a tumor removed during surgery or a biopsy sample, and non-invasive imaging data (e.g., an ultrasound image). In one embodiment, the recurrence assessment system and method generates a fused image combining the images from the non-invasive imaging modality and the histopathological image, wherein the fused image is extended (predicted/out-painted) to the border zone. This solution ensures that the physician has included the surrounding tissues in the analysis and provides additional information based on the histopathological image, which may increase the chances of detecting cancerous tissues in the regional recurrence. Alternatively or additionally, certain embodiments of the recurrence assessment system and method may provide a numeric or alphanumeric value of a probability (e.g., a risk score) of residual malignant cells remaining in the patient. The value may be visually displayed, and in some embodiments, graphically represented, such as via a scale or color or color scale or other visually perceptible representation of the tumor risk/probability.

Another solution of certain embodiments of a recurrence assessment system and method provides a prediction of recurrence of disease (e.g., an oncological disease) in the operated region of a patient via a longitudinal data analysis study based on combining images of the region of interest (e.g., tumor+surrounding zone) after several imaging scans. For instance, it is recognized that a patient whom undergoes cancer removal surgery needs to be periodically re-scanned to spot possible recurrence, the periodic image scans occurring over a period of time throughout the year and/or over a several years' timeframe. For instance, a patient that underwent surgery may see a physician several times a year for a post-surgical checkup. Non-invasive imaging modalities (e.g., ultrasound imaging) may be applied to acquire post-surgical images of the region that has been operated upon. In one embodiment, the recurrence assessment system and method uses the intra-operational data (e.g., histopathological image and non-invasive, e.g., ultrasound image registered during the surgery) as a reference image and compares this with the post-surgical data (e.g., non-invasive image only) at each scan of the patient. Provided with this historical data, the recurrence assessment system and method predicts a risk score of a lesion recurrence through a predictive model. Additionally, the recurrence assessment system and method may define the risk area in the post-surgical region, or generate a fused image predicting a histopathologic image without actually making a biopsy.

For each of the solutions described immediately above, certain embodiments of the recurrence assessment system and method rely on data-driven techniques that use Machine Learning techniques to learn the underlying correlation between histopathological images and non-invasive images. These hidden correlations may be used to translate non-invasive imaging to histopathology imaging to out-paint the histopathology image to the border zone that was not removed from a patient and to predict the presence of malignant cells. Effectively, by using the techniques described herein, a fused image of histology/imaging types is generated considering the initial histology scan and the imaging scans taken along a certain period of time. The hidden correlations may be extracted in a longitudinal domain to observe how the tissues evolve in a non-invasive image domain with time, and are used to predict how these changes should be depicted in a histopathology image.

In one embodiment, the recurrence assessment system and method achieves the above by using the following components: (a) Feature extraction for extracting images from the intra-operational histopathological image F_{histo,0} and the respective registered non-invasive image (e.g., ultrasound) F_{us,0}; (b) Feature extraction for extracting images from the set of post-surgical checkup imaging data (e.g., ultrasound) F_{us,1}, where t stands for the time point when a checkup was conducted; (c) Defining the correlation (or a joint probability) Pₕᵢₛₜₒ₋ₜₒ₋ᵤₛ between the histopathological features F_{histo,0} and the intra-operational ultrasound F_{us,0} to determine how the image representations of ultrasound images are related to the histopathological image; (d) Defining a trajectory T_{us,0-t} in the feature space (see, e.g., Mi, Lu, et al. “Revisiting Latent-Space Interpolation via a Quantitative Evaluation Framework.” arXiv preprint arXiv: 2110.06421 (2021), incorporated herein by reference) between features of the intra-operational F_{us,0} and post-surgical F_{us,t} ultrasound images via a latent space interpolation technique (see, e.g., Barr, Brian, et al. “Counterfactual explanations via latent space projection and interpolation.” arXiv preprint arXiv: 2112.00890 (2021), incorporated herein by reference) to obtain a predictive model explaining how the ultrasound image evolves over time; (e) Given a trajectory T_{us,0-t} (predictive model) of ultrasound image evolution with time and correlation between histopathological and ultrasound image Pₕᵢₛₜₒ₋ₜₒ₋ᵤₛ, predict ultrasound images (with a generative model) or respective features (with a regression model) for the next point in time F_{us,t+1} and map it to the histopathological features F_{histo,t+1}; and (f) Evaluate the predicted histopathological feature F_{histo,t+1} to define whether the recurrence of malignant cells is likely to occur.

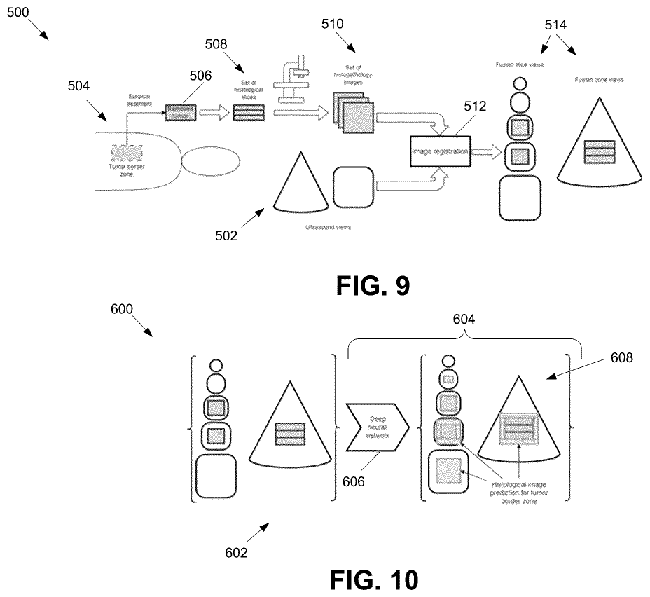

FIG. 9 illustrates a clinical application of an embodiment of the recurrence assessment system and method, and more specifically an example in-operation fusion of ultrasound and histopathology imaging. In one embodiment, this clinical process, denoted process 500, starts with a non-invasive imaging 502 (e.g., ultrasound image acquisition), before the surgical operation. After the surgical operation (504), the tumor tissues (506) are prepared for histopathological assessment (508). A set of histopathological images (510) is registered to the previously saved pre-operation ultrasound images (512). As a result, a fused ultrasound-pathological image is acquired (514). Feature representations of the histopathological and ultrasound images are extracted with a neural network and a correlation (or a joint probability) Pₕᵢₛₜₒ₋ₜₒ₋ᵤₛ between them is defined.

FIG. 10 illustrates an example image out-painting process 600 based on a deep neural network for predicting cancerous cells of a tumor border zone remaining in a patient. With the joint probability Pₕᵢₛₜₒ₋ₜₒ₋ᵤₛ defined (e.g., from process 500), an embodiment of the recurrence assessment system and method may be applied in real-time to convert the ultrasound images into pathological ones and fuse these together (602). After the fusion, the out-painting step (604) is performed, the out-painting method being based on a deep neural network (606), and joint probability Pₕᵢₛₜₒ₋ₜₒ₋ᵤₛ is applied to the fused images (602) to expand the region of ultrasound visualization to take into account surrounding tissues for prediction/analysis of cancer cells (608).

In one embodiment, the recurrence assessment system and method operates dynamically, and the result is displayed to a physician in real-time. Recapping the processes 500-600 implemented in certain embodiments of the recurrence assessment system and method, after the surgery new ultrasound images are registered without disrupting the clinical flow. Then, the new images are passed to a neural network for feature extraction. The extracted ultrasound image features are mapped to predicted histopathologic features via the joint probability Pₕᵢₛₜₒ₋ₜₒ₋ᵤₛ. A generative neural network converts the predicted histopathologic features into a histopathologic image. As a result, the deep neural network synthesizes histological images for tumor border zones that were not affected during the surgical operation and hence were not removed from the patient. Thus, physicians can analyze whether malignant cells are remaining in the border zone based on having access to both imaging and histology data.

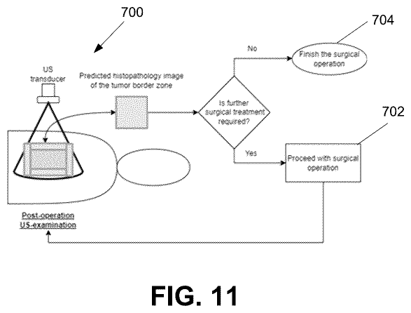

Additionally, and as indicated above, predictive post-operation ultrasound examination may be applied. FIG. 11 illustrates an example post-operation medical ultrasound examination 700 of a patient for determining whether a further surgical treatment of surrounding tissue is warranted. The previously generated expanded histopathological image is dynamically registered to ultrasound images acquired in real time. In some embodiments, registration may also be performed on a workstation after the operation to analyze the tumors e.g., before the operation commences so that the operating physician has more information on the amount of surrounding healthy tissue that needs to be removed. A physician may examine the tumor border zone with fused ultrasound and predicted histopathological images either in real-time or on a workstation after the imaging examination has occurred. This information is used to make a decision, whether further surgical treatment of surrounding tissues is needed (702), whether the physician should expand the treatment region, or the current results of the treatment are acceptable (704).

As is evident from at least FIGS. 9-11 and the corresponding description, certain embodiments of the recurrence assessment system and method are based on using non-invasive imaging (e.g., a medical ultrasound system) and histopathology imaging. Additional functionality is used to implement the recurrence assessment system and method, as described below. In one embodiment, the recurrence assessment system and method implements an image registration method for ultrasound and histopathology images fusion (e.g., as described in conjunction with FIGS. 3-8). The image registration may be based on either classical computer vision or deep learning models. In the former case, partial matching of shape-informative boundaries may be used (see, e.g., Pichat, Jonas, et al. “Part-to-whole registration of histology and mri using shape elements.” Proceedings of the IEEE International Conference on Computer Vision Workshops. 2017; Pichat, Jonas. Registration of histology and magnetic resonance imaging of the brain. Diss. UCL (University College London), 2019; both of which are incorporated herein by reference). In the latter case, a convolutional neural network may be trained to predict the displacement required to align two images (see, e.g., Carey, Harry, et al. “DeepSlice: rapid fully automatic registration of mouse brain imaging to a volumetric atlas.” bioRxiv (2022), which is incorporated herein by reference).

In one embodiment, the recurrence assessment system and method also implements an image out-painting method based on deep neural network for expanding histopathology visualization of the surrounding tissues (e.g., as described in association with FIG. 10). The image out-painting method may be based on several deep learning frameworks, including: Generative-adversarial network framework that includes structural edge map generator, edge discriminator, image completion generator, and image completion discriminator (see, e.g., Kim, Kyunghun, et al. “Painting outside as inside: Edge guided image outpainting via bidirectional rearrangement with progressive step learning.” Proceedings of the IEEE/CVF Winter Conference on Applications of Computer Vision. 2021, incorporated herein by reference); Taming transformers for high-resolution image synthesis framework that is based on convolutional neural network for learning a context-rich vocabulary of image compartments and transformer to efficiently model their composition within high-resolution images (see, e.g., Esser, Patrick, Robin Rombach, and Bjorn Ommer. “Taming transformers for high-resolution image synthesis.” Proceedings of the IEEE/CVF conference on computer vision and pattern recognition. 2021, incorporated herein by reference); Masked generative image transformer that generates all patches of image simultaneously, and then iteratively refines the whole image conditioned on the previous generation step (see, e.g. Chang, Huiwen, et al. “Maskgit: Masked generative image transformer.” Proceedings of the IEEE/CVF Conference on Computer Vision and Pattern Recognition. 2022, incorporated herein by reference); Transformer-based generative adversarial neural network for generalized image out-painting problem that uses encoder-to-decoder generator embedded with Swin Transformer blocks (see, e.g., Gao, Penglei, et al. “Generalised Image Outpainting with U-Transformer.” arXiv preprint arXiv: 2201.11403 (2022), incorporated herein by reference); Denoising diffusion probabilistic model that is an emerging alternative paradigm for generative modelling (see, e.g., Lugmayr, Andreas, et al. “Repaint: Inpainting using denoising diffusion probabilistic models.” Proceedings of the IEEE/CVF Conference on Computer Vision and Pattern Recognition. 2022, incorporated herein by reference); Autoregressive generation framework for infinite visual synthesis (NUWA-Infinity), where a global patch-level autoregressive model considers the dependencies between patches, and a local token-level autoregressive model considers the dependencies between visual tokens within each patch. The key advantage of this framework is an ability of generating arbitrarily sized high-resolution images (see, e.g., Wu, Chenfei, et al. “NUWA-Infinity: Autoregressive over Autoregressive Generation for Infinite Visual Synthesis.” arXiv preprint arXiv: 2207.09814 (2022), incorporated herein by reference).

For training the out-painting deep neural network (e.g., 606 of FIG. 10), the following data (a)-(b) may be used: (a) the removed tumor tissue or a biopsy sample should be prepared for histopathological visualization so that the central patch of the tumor tissue (histopathology patch) may be used as an input for training the neural network, and the surrounding tissues may be used as an expected output of the model; (b) the respective ultrasound images containing tumor. Additionally, each histopathological patch should be accompanied by a value (e.g., score) characterizing the malignancy. This score may be annotated by a pathologist and used as a target of the model. The model should be trained to predict the score as a measure of tumor reoccurrence risk for the surrounding tissues.

To train the out-painting model, in one embodiment, histopathological and ultrasound images should be used as an input. The former plays a role of a prior information, and the latter is a condition. The neural network projects both inputs to the latent space. The expected output contains a histopathological image of the surrounding area and risk score value. The neural network may be trained as a generative model: it learns a joint distribution defining what the histopathological image of surrounding areas looks like given the respective ultrasound image and respective central histopathological patch. In one embodiment, the model may be trained in a discriminative fashion (e.g., the model learns a conditional distribution defining the likelihood of a presence of tumor cells in the tumor surgery border zone and/or the likelihood of a reoccurrence of a tumor).

Note that certain embodiments of the recurrence assessment system and method may be implemented on a medical device cart or on a workstation, and may provide a GUI-based application that may be used by a physician. In some embodiments, the recurrence assessment system and method may be implemented on a US device, a visualization station like the ISP, and/or via Dynacad/Uronav-types of applications. Such an application embodiment enables visualization of a fused image, combining an out-painted histopathological image and non-invasive imaging modality (US, MRI, CT) and/or a predicted risk for a malignant tumor recurrence.

Certain embodiments of the recurrence assessment system and method may be used as a decision support system for quality assessment of surgical operations on malignant tumors (e.g., to prove that all malignant cells were removed, and the disease reoccurrence is less likely to happen). Alternatively or additionally, certain embodiments of the recurrence assessment system and method may be used as a post-surgical screening system that predicts a risk of malignant tumor development in the post-surgery region.

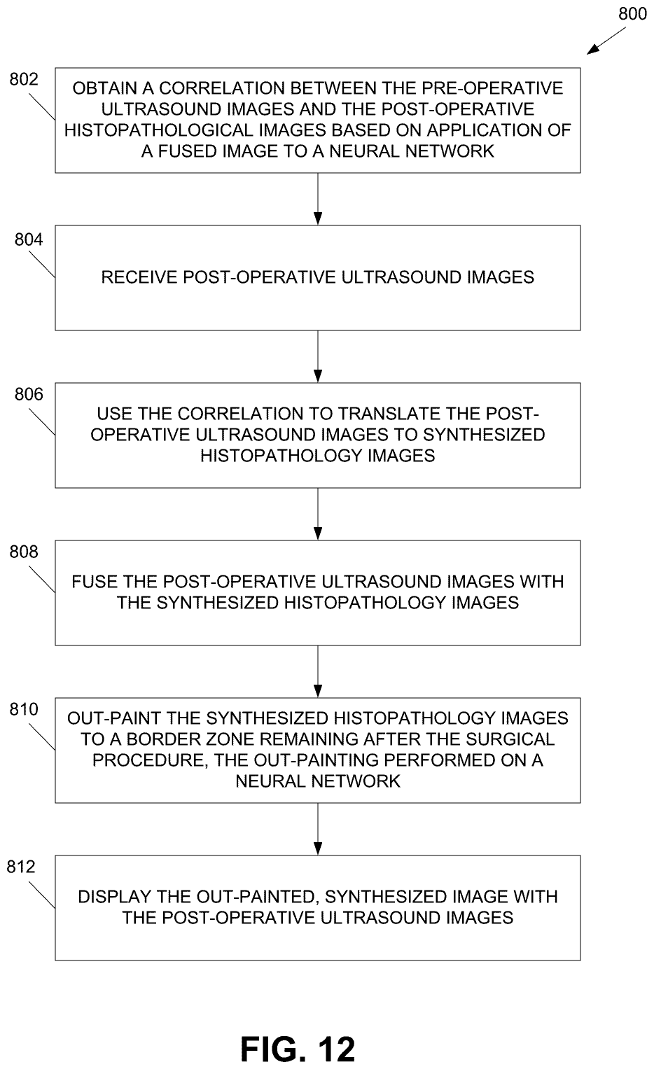

In view of the description above, it should be appreciated that one embodiment of an example recurrence assessment method, denoted as method 800 and shown in FIG. 12, comprises obtaining a correlation between the pre-operative ultrasound images and the post-operative histopathological images based on application of a fused image to a neural network (802); receiving post-operative ultrasound images (804); using the correlation to translate the post-operative ultrasound images to synthesized histopathology images (806); fusing the post-operative ultrasound images with the synthesized histopathology images (808); out-painting the synthesized histopathology images to a border zone remaining after the surgical procedure, the out-painting performed on a neural network (810); and displaying (or providing for displaying) the out-painted, synthesized image with the post-operative ultrasound images (812).

Any process descriptions or blocks in the flow diagram of FIG. 12 should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

The described disclosure may be provided as a computer program, or software that may include a non-transitory computer-readable storage medium having stored thereon instructions, which may be used to program a computer system (or other electronic devices) to perform a process according to the present disclosure. A non-transitory computer-readable storage medium includes any mechanism for storing information in a form (e.g., software, processing application) readable by a computer. In various implementations, the processor may be associated with one or more storage media such as volatile and non-volatile computer memory. The non-transitory computer-readable storage medium may include, but is not limited to, optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions. RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor.

Variations to the disclosed embodiments can be understood and effected by those of ordinary skilled in the art in practicing the claimed invention, from a study of the drawings, the disclosure and the appended claims. In the claims, the word “comprising” does not exclude other elements or steps, and the indefinite article “a” or “an” does not exclude a plurality.

It is understood that one or more of the embodiments of the invention may be combined as long as the combined embodiments are not mutually exclusive. As will be appreciated by one skilled in the art, aspects of the present invention may be embodied as an apparatus, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “device”, “module” or “system.” Furthermore, aspects of the present invention may take the form of a computer program product embodied in one or more non-transitory computer readable medium(s) having computer executable code embodied thereon.

Functions implemented by a processor may be implemented by a single processor or by multiple separate processing units which may together be considered to constitute a “processor”. Such processing units may in some cases be remote from each other and communicate with each other in a wired or wireless manner. A processor may include a software executing device and/or dedicated hardware, such as an application-specific integrated circuit (ASIC) and/or a field-programmable gate array (FPGA).

Measures recited in mutually different dependent claims may be advantageously combined.

A computer program may be stored/distributed on a suitable medium, such as an optical storage medium or a solid-state medium supplied together with or as part of other hardware, but may also be distributed in other forms, such as via the Internet or other wired or wireless telecommunication systems. A non-transitory computer-readable storage medium can be used.

As will be appreciated by one skilled in the art, aspects of the present invention may be embodied as an apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable medium(s) having computer executable code embodied thereon. Any combination of one or more non-transitory computer readable medium(s) may be utilized. A non-transitory ‘computer-readable storage medium’ as used herein encompasses any tangible storage medium which may store instructions which are executable by a processor or computational system of a computing device. The non-transitory computer-readable storage medium may be referred to as a computer-readable non-transitory storage medium. The non-transitory computer-readable storage medium may also be referred to as a tangible computer readable medium. A non-transitory computer readable signal medium may include a propagated data signal with computer executable code embodied therein, for example, in baseband or as part of a carrier wave.

‘Computer memory’ or ‘memory’ is an example of a non-transitory computer-readable storage medium. Computer memory is any memory which is directly accessible to a computational system. ‘Computer storage’ or ‘storage’ is a further example of a non-transitory computer-readable storage medium. Computer storage is any non-volatile computer-readable storage medium. In some embodiments computer storage may also be computer memory or vice versa.

Machine executable instructions or computer executable code may comprise instructions or a program which causes a processor or other computational system to perform an aspect of the present invention. Computer executable code for carrying out operations for aspects of the present invention may be written in any combination of one or more programming languages, including an object-oriented programming language such as Java, Smalltalk, C++ or the like and conventional procedural programming languages, such as the “C” programming language or similar programming languages and compiled into machine executable instructions. In some instances, the computer executable code may be in the form of a high-level language or in a pre-compiled form and be used in conjunction with an interpreter which generates the machine executable instructions on the fly. In other instances, the machine executable instructions or computer executable code may be in the form of programming for programmable logic gate arrays.

Aspects of the present invention are described with reference to flowchart illustrations and/or block diagrams of methods, apparatus (systems) and computer program products according to embodiments of the invention. It is understood that each block or a portion of the blocks of the flowchart, illustrations, and/or block diagrams, can be implemented by computer program instructions in form of computer executable code when applicable. It is further understood that, when not mutually exclusive, combinations of blocks in different flowcharts, illustrations, and/or block diagrams may be combined. These computer program instructions may be provided to a computational system of a general-purpose computer, special purpose computer, or other programmable data processing apparatus to produce a machine, such that the instructions, which execute via the computational system of the computer or other programmable data processing apparatus, create means for implementing the functions/acts specified in the flowchart and/or block diagram block or blocks.

The computer executable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Procedures like acquiring image data from the first pathology imaging modality, acquiring image data from the second imaging modality, registering the images, mapping the images, applying an image generation device, visualizing the images, et cetera, performed by one or several units or devices can be performed by any other number of units or devices. These procedures can be implemented as program code means of a computer program and/or as dedicated hardware.

Any reference signs in the claims should not be construed as limiting the scope.

At least the following is claimed:

1. A method, comprising:
obtaining a correlation between the pre-operative ultrasound images and the post-operative histopathological images based on application of a fused image to a neural network;
receiving post-operative ultrasound images;
using the correlation to translate the post-operative ultrasound images to synthesized histopathology images;
fusing the post-operative ultrasound images with the synthesized histopathology images;
out-painting the synthesized histopathology images to a border zone remaining after the surgical procedure, the out-painting performed on a neural network; and
displaying the out-painted, synthesized image with the post-operative ultrasound images.

2. The method of claim 1, wherein using the correlation to translate the post-operative ultrasound images to synthesized histopathology images comprises:
extracting ultrasound image features using a neural network;
mapping the extracted ultrasound image features to predicted histopathologic features based on the correlation; and
converting the predicted histopathological features into the synthesized histopathological images, the conversion performed on a neural network.

3. The method of claim 1, further comprising predicting a probability of residual malignant cells remaining in a border zone after a surgical procedure that removes diseased tissue from a region of surgical treatment, the border zone adjacent the region of surgical treatment.

4. The method of claim 3, wherein predicting the probability comprises providing a value indicative of the probability.

5. The method of claim 3, wherein predicting the probability comprises providing one or a combination of a numeric value, an alphanumeric value, or a graphical indication of the probability.

6. The method of claim 1, further comprising registering the synthesized histopathology images to ultrasound images taken over a span of time as a follow-up to the surgical procedure.

7. The method of claim 6, wherein the span of time occurs over a year or several years.

8. The method of claim 1, wherein displaying the out-painted, synthesized image with the post-operative ultrasound images enabling a determination of whether a further surgical procedure for removing diseased tissue from the border zone is warranted or whether current results of an initial surgical procedure that removed diseased tissue from a region of surgical treatment are acceptable.

9. The method of claim 1, further comprising, prior to the obtaining of the correlation between the pre-operative ultrasound images and the post-operative histopathological images:
receiving the pre-operative ultrasound images of diseased tissue;
receiving the post-operative histopathological images of the diseased tissue, the post-operative histopathological images from a surgical procedure that extracts a target zone of a diseased tissue; and
obtaining the fused image based on the pre-operative ultrasound images and the post-operative histopathological images.

10. A system, comprising:
an ultrasound imaging device;
a pathology scanner;
one or more processors; and
memory comprising instructions, the one or more processors configured by the instructions to:
obtain a correlation between the pre-operative ultrasound images and the post-operative histopathological images based on application of a fused image to a neural network;
receiving post-operative ultrasound images;
use the correlation to translate the post-operative ultrasound images to synthesized histopathology images;
fuse the post-operative ultrasound images with the synthesized histopathology images;
out-paint the synthesized histopathology images to a border zone remaining after the surgical procedure, the out-painting performed on a neural network; and
provide for display the out-painted, synthesized image with the post-operative ultrasound images.

11. The system of claim 10, wherein the one or more processors are configured by the instructions to use the correlation to translate the post-operative ultrasound images to synthesized histopathology images by:
extracting ultrasound image features using a neural network;
mapping the extracted ultrasound image features to predicted histopathologic features based on the correlation; and
converting the predicted histopathological features into the synthesized histopathological images, the conversion performed on a neural network.

12. The system of claim 10, wherein the one or more processors are further configured by the instructions to predict a probability of residual malignant cells remaining in a border zone after a surgical procedure that removes diseased tissue from a region of surgical treatment, the border zone adjacent the region of surgical treatment.

13. The system of claim 12, wherein the one or more processors are configured by the instructions to predict the probability by providing a value indicative of the probability.

14. The system of claim 12, wherein the one or more processors are configured by the instructions to predict the probability by providing one or a combination of a numeric value, an alphanumeric value, or a graphical indication of the probability.

15. The system of claim 10, wherein the one or more processors are configured by the instructions to register the synthesized histopathology images to ultrasound images taken over a span of time as a follow-up to the surgical procedure.

16. The system of claim 15, wherein the span of time occurs over a year or several years.

17. The system of claim 10, wherein the display of the out-painted, synthesized image with the post-operative ultrasound images enables a determination of whether a further surgical procedure for removing diseased tissue from the border zone is warranted or whether current results of an initial surgical procedure that removed diseased tissue from a region of surgical treatment are acceptable.

18. The system of claim 10, wherein the one or more processors are further configured by the instructions to, prior to the obtaining of the correlation between the pre-operative ultrasound images and the post-operative histopathological images:
receive the pre-operative ultrasound images of diseased tissue;
receive the post-operative histopathological images of the diseased tissue, the post-operative histopathological images from a surgical procedure that extracts a target zone of a diseased tissue; and
obtain the fused image based on the pre-operative ultrasound images and the post-operative histopathological images.

19. A non-transitory, computer readable medium encoded with instructions, wherein when the instructions are executed on one mor more processors, causes the one or more processors to:
obtain a correlation between the pre-operative ultrasound images and the post-operative histopathological images based on application of a fused image to a neural network;
receiving post-operative ultrasound images;
use the correlation to translate the post-operative ultrasound images to synthesized histopathology images;
fuse the post-operative ultrasound images with the synthesized histopathology images;
out-paint the synthesized histopathology images to a border zone remaining after the surgical procedure, the out-painting performed on a neural network; and
provide for display the out-painted, synthesized image with the post-operative ultrasound images.

20. The non-transitory, computer readable medium of claim 19, wherein when the instructions are executed on one mor more processors, further causes the one or more processors to:
predict a probability of residual malignant cells remaining in a border zone after a surgical procedure that removes diseased tissue from a region of surgical treatment, the border zone adjacent the region of surgical treatment.
